(19) United States
(12) Patent Application Publication
(10) Pub. No.: US 2004/0230331 A1
(43) Pub. Date: Nov. 18, 2004

(54) Multi-user network audio system on UNIX-based operating systems

(76) Inventor: Gwan-Hwan Hwang, Hsinchu (TW)

Correspondence Address: KNOBBE MARTENS OLSON & BEAR LLP, 2040 MAIN STREET, FOURTEENTH FLOOR, IRVINE, CA, 92614, US

(21) Appl. No.: 10/439,721

(22) Filed: May 15, 2003

(51) Int. Cl. G06F 17/00

(52) U.S. Cl. 700/94

(57) ABSTRACT

The present invention provides a multi-user network-transparent audio system (MuNAS) on UNIX-based operating systems. The implementation of the MuNAS includes making some audio data relays for users, embedding a system-call serializer in the kernel of the UNIX operating system, and executing daemon processes in the audio-sending and audio-receiving computers. In addition to basic network audio functionality of transmitting audio data through a network connection and playing it from another computer, the system of the present invention has the following features. First, it is designed to work on multi-user operating systems: several users can activate the network audio system by executing their own audio applications in the same computer and their audio data can be forwarded to different computers simultaneously. Second, existing audio applications do not need to be modified or recompiled, and no additional libraries are required. Third, the program is not restricted to any special form of audio data format or device type; i.e., the audio applications can arbitrarily define their own audio data formats and device types. Fourth, the system allows the audio mixing of audio data from different processes of a user.

### FIELD OF THE INVENTION

The present invention relates to a network audio system and more particularly to a multi-user network audio system on Unix-based operating systems.

### BACKGROUND OF THE INVENTION

The X Window system, or more simply “X” or “X11”, is the de facto standard graphical engine for UNIX-based operating systems (including Linux), and provides the only common windowing environment bridging heterogeneous platforms in today's enterprise computing systems. Thousands of independent software developers provide applications that run on the X Window system, and the worldwide community of users of the X Window system currently exceeds 30 million. One of the strengths of the X Window system is that it supports the thin-client/server computing model, which consists of three key components (please refer to FIG. 1): thin-client hardware devices 1a (known as X-terminals in the X Window system), an application server 1b, and a display protocol. All the applications and data are deployed, managed, supported, and executed at the application server 1b. Thin-client devices 1a gather inputs from users in the form of mouse clicks and keystrokes, send them to the application server 1b for processing, and collect screen updates as the response from the application server 1b. All the interactions between thin-client devices 1a and the application server 1b occur via an efficient display protocol.

Unfortunately, the display protocol of the X Window system does not support the transmission of audio data. In a UNIX-based operating system, the standard way for application programs to output sampled audio data to an audio hardware device is to invoke a sequences of open, ioctl, write, and close system calls to some audio device files such as “/dev/audio”, “/dev/dsp”, “/dev/mixer”, “/dev/sndstat”, “/dev/sequencer”, “/dev/music”, “/dev/midi”, “/dev/dmfm”, and “/dev/dmmidi”. These system calls can only deliver audio data to the local audio hardware device—they cannot deliver audio data to an audio hardware device in another computer. Thus, all the programs executing in the application server cannot use the standard way of delivering audio data to a thin-client device.

Several methods have been proposed for overcoming the lack of network audio functionality in the X Window system and for implementing audio applications in UNIX-based operating systems, such as Jim Fulton and Greg Renda, “The Network Audio System”, http://radscan.com/nas/docs/xcon94paper.ps; Ray Tice and Mark Welch, “The Broadway Audio System”, http://www.x.org/contrib/audio/Xaudio/xtech96/xtech96_slides.html; and Bemardo Innocenti, “The Basic Network Audio System (BNAS)”, http://www.codewiz.org/projects/unix/bnasl.

One of the solutions is to define and provide a network audio library (Jim Fulton and Greg Renda; Ray Tice and Mark Welch), whereby all the programs (or processes) that want to send audio data over the network must invoke subroutines in this library. This solution can be applied to a multi-user environment since the network audio library will arrange a separate channel to transmit audio data for each user. However, programs that use the standard way to send audio data (i.e., invoking a sequences of open, ioctl, write, read, and close system calls) cannot work in this kind of environment. Instead, these programs must be redesigned to invoke the subroutines in the new network audio library. Another drawback of this scheme is that the program cannot use any audio data format or device types that are not defined in the network audio library.

The basic network audio system (BNAS) proposed by Innocenti does not rely on a new network audio library, removing the need to modify or recompile existing programs. Instead, it uses a FIFO special file to redirect the audio data sent to “/dev/audio”. However, this system cannot support multi-user operation, so that all the audio data delivered by the programs of different users must be forwarded to the same destination. Also, the original audio hardware device in the application server must be turn off during operation.

In addition, audio systems such as the open sound system (http://www.opensound.com) in Unix have a problem that an audio device can only be used by a single process simultaneously. The problem can also be solved in the present invention.

### SUMMARY OF THE INVENTION

The present invention discloses a multi-user network audio system (abbreviated as MuNAS) that can work in any UNIX-based operating system. First, it is designed to work on a multi-user operating system—several users can activate the network audio system by executing their own audio applications in the same computer, with their audio data capable of being forwarded to different computers simultaneously. Second, existing audio applications do not need to be modified or recompiled, and no additional libraries are required. Third, the program is not restricted to any special form of audio data format or device type; i.e., the audio applications can arbitrarily define their own audio data formats and device types. And fourth, its architecture allows audio mixing of audio data from different processes of a user.

In addition to being a multi-user network audio system, the MuNAS can also be an audio mixer in a standalone computer. The MuNAS can have audio applications which use the same audio device execute simultaneously and perform audio mixing automatically.

The implementation of the MuNAS includes making audio data relays for users, embedding a system-call serializer in the kernel of the UNIX operating system, and executing daemon processes in the audio-sending and audio-receiving computers. An audio data relay can be either a FIFO special file, a message queue of interprocess communication, or similar mechanisms. And the system-call serializer can be implemented by either modifying several system calls in the kernel or writing a new device driver for sound device.

The MuNAS of the present invention has been implemented in Red Hat Linux 7.2 (kernel version 2.4.7-10) and 8.0 (kernel version 2.4.18-14). And the system has been tested using audio applications including the demonstration program in OSS/Lite Audio Programming (Eelke Klein, http://www.geocities.com/SiliconValley/Horizon/3991/lspaudio.html), the GNOME window manager, and several MPEG-3 decoders such as “gtv”, “xmms”, “mpg123”, “mplayer”, “gmplayer”, “alsaplayer”, and “realplayer”. The MuNAS performs well, as indicated by its ability to send stereo, 16-bit, 44.1 -kHz linear audio data to several users in the same Linux PC simultaneously. The scheme proposed in the present invention can be applied to any UNIX-based operating system.

Advantages and spirit of the present invention can be further understood by the following detailed description of the invention and drawings.

### BRIEF DESCRIPTION OF THE DRAWINGS

FIG. 1 depicts a thin-client/server computing model;

FIG. 2 depicts an architecture of the multi-user network audio system of the present invention;

FIG. 3A depicts an embodiment of system-call serializer;

FIG. 3B depicts another embodiment of system-call serializer;

FIG. 4A depicts an embodiment of an audio mixer in a standalone computer; and

FIG. 4B depicts another embodiment of an audio mixer in a standalone computer.

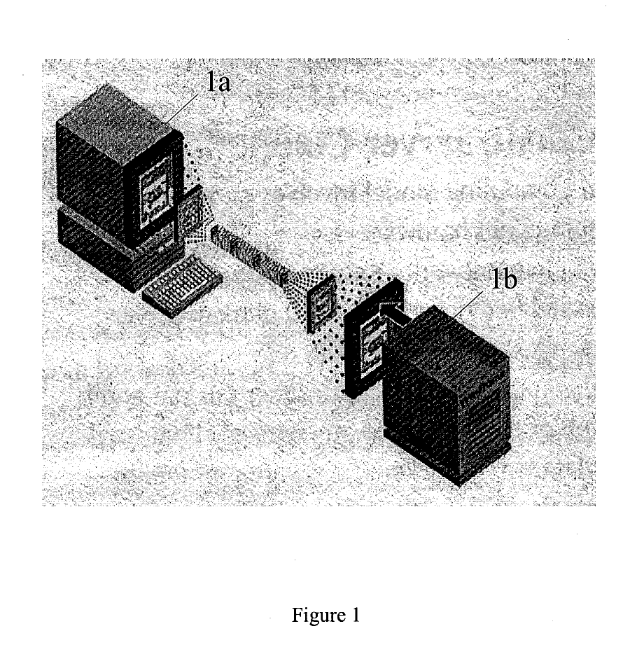

### DETAILED DESCRIPTION OF THE INVENTION

Introduction to Audio Programming in UNIX

There are several audio devices that can be accessed by an application program in a UNIX operating system; e.g., Red Hat Linux 7.2 and 8.0 include “/dev/audio”, “/dev/dsp”, “/dev/mixer”, “/dev/sndstat”, “/dev/sequencer”, “/dev/music”, “/dev/midi”, “/dev/dmfm”, and “/dev/dmmidi”. For simplicity, the audio device file “/dev/dsp” is used in the present invention for illustration. Actually, “/dev/dsp” is one of the most important audio device files in the Linux operating system, and the application program uses some system calls to operate the audio device which binds on this device, including open, read, write, ioctl, and close. First, the program uses the open system call to open the device file with correct file access permission. In the following code fragment, the first and second arguments of the open system call are path name and file access permission, respectively. If the open system call is successful, the program uses the file descriptor fd to perform the subsequent write, ioctl, and close system calls.

int fd;

fd=open(“/dev/dsp”,0_WRONLY);

The program then invokes a sequence of ioctl system calls, which set parameters such as buffer size, number of channels, sample format, and sampling rate of the audio device. Examples of these are shown in the following code fragments, which are extracted from Eelke Klein's works (“OSS/Lite Audio Programming”, http://www.geocities.com/SiliconValley/Horizon/3991 /lspaudio.html.):

if (ioctl(fd, SNDCTL_DSP_SETFRAGMENT,&setting)==−1) perror(“ioctlset fragment”);

if (ioctl(fd, SNDCTL_DSP_STEREO,&channels)==−1) perror(“ioctlstereo”);

if (ioctl(fd, SNDCTL_DSP_SETFMT, &format)==−1) perror(“ioctlformat”);

if (ioctl(fd, SNDCTL_DSP_SPEED, &rate)==−1) perror(“ioctlsample rate”);

After the audio device is set, the program can perform a series of write system calls to send audio data to the audio device, e.g., write(fd, data, size_of(data)), in which data is an array that stores the audio data. Finally, the program uses a close system call to inform the audio device that the transmission of audio data is over, e.g., close(fd).

Architecture and Implementation of MuNAS

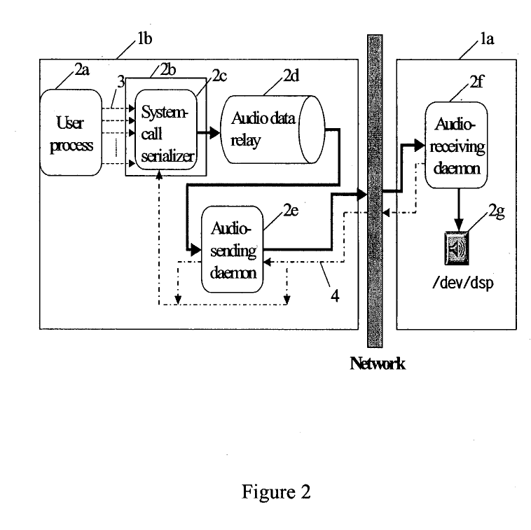

The multi-user network audio system (MuNAS) of the present invention requires addition of several components into UNIX operating systems. Please refer to FIG. 2. First, in a local computer 1b, a system-call serializer 2c is embedded in kernel 2b. The local computer 1b is generally an application server.

System calls 3 that are issued by a user process 2a to an audio device 2g “/dev/dsp” in a remote computer 1a are serially redirected to an audio data relay 2d by the system-call serializer 2c. The remote computer 1a can be a thin-client device or any other devices that connect to the local computer 1b.

An audio-sending daemon 2e, which is a continuously running process, retrieves serialized system calls stored in the audio data relay 2d and sends the system calls to an audio-receiving daemon 2f in a remote computer 1a via a network.

The audio-receiving daemon 2f deserializes the serialized system calls, and then invokes open, write, read, ioctl, and close system calls to the audio device 2g “/dev/dsp” of the remote computer 1a. The deserializing of the serialized system calls performed by the audio-receiving daemon 2f is accomplished by parsing the received serialized system calls to identify system calls from different processes. Preferably the audio-receiving daemon 2f further performs audio mixing after parsing the received serialized system calls. Details of these components are further described in the following.

Audio Data Relay

An audio data relay can be a FIFO special file, a message queue of interprocess communication, or similar mechanisms. Since the ways to implement an audio data relay in these mechanisms are very similar, only the way of making an audio data relay in a FIFO special file is presented.

Each user in the system of the present invention is provided with a FIFO special file. In UNIX, a FIFO special file (a named pipe) is similar to a pipe, except that it is accessed as part of the file system. It can be opened by multiple processes for reading or writing. When processes are exchanging data via the FIFO, the kernel passes all data internally without writing them to the file system.

This FIFO file is used as a relay of the audio data (the audio data relay). Note that the audio data relay is user-specific, i.e., each user has her or his own audio data relay. The open, write, ioctl, and close system calls invoked by the processes of one user will be serialized and sent to the audio data relay of that user. A naming scheme is required to differentiate the audio data relays belonging to different users. In one embodiment, the file name of the audio data relay appends the user ID of the user in the UNIX system to “/tmp/myDSP_” (e.g., if there is a user with ID 500, then the file name of her or his audio data relay is “/tmp/myDSP_{—}500”).

The System-Call Serializer

FIG. 2 shows that the system calls 3, such as open, write, ioctl, and close system calls, to the audio device 2g “/dev/dsp” issued by the user process 2a are serialized and sent to the user's audio data relay 2d. The functionality of the system-call serializer is to encode the name and all the arguments of an invoked system call into a stream of bytes.

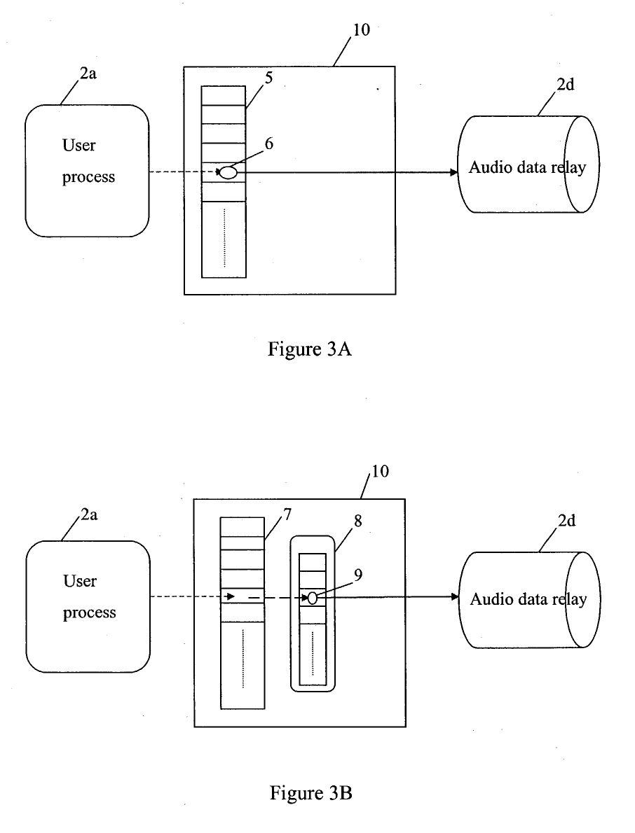

Two embodiments are provided in the invention to implement and embed the system-call serializer in the kernel: one is to modify several system calls in kernel 10 (as depicted in FIG. 3A) and the other is to write a new device driver 8 for sound device (as depicted in FIG. 3B). Both schemes are implemented in Red Hat Linux 7.2 and 8.0. The difference between the two implementations is that the former scheme has to check if the system call is executed on the device file of the sound device but the latter one does not have to do it. It is because only these system calls which are executed on the device files of the sound device will invoke the corresponding functions in the device driver.

Modifications to Unix System Calls

At least the open, ioctl, write, and close system calls in the kernel of the UNIX operating system have to be modified. Note that the read system call needs to be modified when implementing the sound recording function in the MuNAS is required. In FIG. 3A, these system calls 5 are serialized in the kernel 10 by a system call serializer 6 so as to send the serialized system calls to the audio data relay 2d. A serialized system call includes its name and all its parameters. When the user invokes these system calls, the system call serializer 6 will first serialize the invoked system calls and then send the serialized system calls to the audio data relay 2d.

Modification of the Open System Call

Program statements are firstly added to the beginning of the open system call (e.g., sys_open in Linux). The modified open system call first executes the added program statements and then the original open system call. The following is the prototype of sys_open in Linux:

long sys_open(const char * filename, int flags, int mode)

The added program statements change the filename argument to the filename of the audio data relay of the user if the original value of filename is “/dev/dsp”. Thus, all the open requests to “/dev/dsp” will be redirected to the audio data relay of the user. After the redirection, the open system call sends a string which is the concatenation of “OPEN”, the ID of the process invoking this open system call, and “|” to the audio data relay. This string is the serialized form of the open system call. For example, if the open system call is issued by a process with ID 1285 belonging to the user with ID 500, then this open system call to “dev/dsp” will be directed to “/tmp/myDSP_{—}500”, and then a string (i.e., the serialized open system call, “OPEN1285|”) will be sent to “/tmp/myDSP_{—}500”.

Modification of the ioctl System Call

Program statements are added to the beginning of the ioctl system call (e.g., sys_ioctl in Linux). The following is the prototype of sys_ioctl in Linux:

long sys_ioctl(unsigned int fd, unsigned int cmd, unsigned long arg)

The first argument fd is the file descriptor of the opened file; this argument is used by the added program statements to first check if it is an ioctl system call to the audio data relay of a user. If this is true, the modified ioctl system call sends a string to the audio data relay of the user issuing the ioctl system call. The string is constructed by concatenating several strings: “IOCT L”, the ID of the process, “|”, the string of the integer cmd, “|”, and array of data pointed by arg (note that “|” is used to separate the arguments). This string is the serialized form of the ioctl system call. For example, if the open system call is issued by a process with ID 1285 belonging to the user with ID 500, then the serialized ioctl system call (e.g., ioctl(handle,SNDCTL_DSP_STEREO,&channels)) will send a string “IOCTL1285|3221508099|1|” to “/tmp/myDSP_{—}500”.

Modification of the Write System Call

The write system call has the following prototype:

sys_write(unsigned int fd, const char * buf, size_t count)

The write system first checks fd to see if it is a write system call to the user's audio data relay. If this is true, then the modified system call first sends a string that is the concatenation of “WRITE”, the ID of the process, “|”, the string form of count, and “|”. For example, a string “WRITE1285|1000|” is sent to the audio data relay if a process with ID 1285 owned by the user with ID 500 would like to use a write system call to send 1000 bytes to “/dev/dsp”. After that, the system executes the original system call issued by the user. Since the write system call to “/dev/dsp” has been redirected to the audio data relay of the user, the data stored in array “buf” will be concatenated to the end of “WRITE1285|1000|”. The string“WRITE1285|10001|-------” is the serialized form of the write system call, note that the “-------” represents the first 1000 bytes of data in array “buf”.

Modification of the Close System Call

The close system call has the prototype sys_close(unsigned int fd). The system call is modified by first checking fd to see if it is a close system call to the audio data relay. If this is true, the modified system call first sends a string which is the concatenation of “CLOSE”, the process ID, and “|” to the audio data relay of the user before the original close system call. This string is the serialized form of the close system call; an example of the string is “CLOSE1285|”.

Writing a New Device Driver

Since each audio device such as “/dev/audio”, “/dev/dsp”, “/dev/mixer”, “/dev/sndstat”, “/dev/sequencer”, “/dev/music”, “/dev/midi”, “/dev/dmfm”, and “/dev/dmmi di” is associated with its device driver in the kernel, a new device driver can be written to install the system-call serializer. The interface to a device is designed to look the same as a file system. In Unix, file systems have a specific set of instructions to access them: seek, read, write, readdr, poll, io control, memory map, open, flush, release, synch, asynch, check media, revalidate, and lock. In order to be accessed through the /dev file system, a device must provide a function call for each of the above file system operations. In FIG. 3B, a system-call serializer 9 is installed in the functions of a device driver 8. As shown in FIG. 3B, system calls 7 issued by the user process 2a will invoke the corresponding functions in the device driver 8. Those functions will serialize the system calls and send them to the audio data relay 2d.

In the following, a loadable kernel module of Linux is used for demonstration. It must be done through a variable of type struct file_operations (declared in linux/include/linux/fs.h):

struct file_operations {

loff_t (*llseek) (struct file *, loff_t, int);
ssize_t (*read) (struct file *, char *, size_t, loff_t *);
ssize_t (*write) (struct file *, const char *, size_t, loff_t *);
int (*readdir) (struct file *, void *, filldir_t);
unsigned int (*poll) (struct file *, struct poll_table_struct *);
int (*ioctl) (struct inode *, struct file *, unsigned int, unsigned long);
int (*mmap) (struct file *, struct vm_area_struct *);
int (*open) (struct inode *, struct file *);
int (*flush) (struct file *);
int (*release) (struct inode *, struct file *);
int (*fsync) (struct file *, struct dentry *);
int (*fasync) (int, struct file *, int);
int (*check_media_change) (kdev_t dev);
int (*revalidate) (kdev_t dev);
int (*lock) (struct file *, int, struct file_lock *);

};

A device driver needs to only define the functions that make sense for it. Thus, device driver of /dev/dsp will primarily need to implement open( ), ioctl( ), write( ), read( ), and close( ), and the other functions can be NULL. Thus, at this point the module header may look roughly like:

#include <linux/kernel.h >
#include <linux/module.h >
#include <linux/fs.h >
/* prototypes for below operations */
int mydev_open(struct inode *inode, struct file *file);
ssize_t mydev_write(struct file *file, const char *buffer, size_t count, loff_t
*ppos);
int mydev_ioctl(struct inode *inode, struct file *file, unsigned int cmd, unsigned
long arg);
int mydev_close(struct inode *inode, struct file *file);
...
/* registration info */
struct file_operations mydev_fops = {

| | |
|---|---|
| NULL, | /* lseek */ |
| NULL, | /* read */ |
| mydev_write, | /* write */ |
| NULL, | /* readdir */ |
| NULL, | /* poll */ |
| mydev_ioctl, | /* ioctl */ |
| NULL, | /* mmap */ |
| mydev_open, | /* open */ |
| NULL, | /* flush */ |
| mydev_close, | /* release */ |
| NULL, | /* sync */ |
| NULL, | /* async */ |
| NULL, | /* check media change */ |
| NULL, | /* revalidate */ |
| NULL, | /* lock */ |

};

/* definitions for above operations below here */
ssize_t mydev_open(struct inode *inode struct file *file)
{

/* The open function in pseudo code*/

let uid be the user id of the invoker
fd=open(“/tmp/myDSP_”+uid, 0_WRONLY, S_IRWXU);
write(fd,“OPEN”+ process id + “I”);

}
ssize_t mydev_ioctl(struct inode *inode, struct file *file, unsigned int cmd,

unsigned long arg)

{

/* The ioctl function in pseudo code */

write(fd,“IOCTL”+ process id + “I” + string of cmd + “I” + array of data pointed

by arg);

}
ssize_t mydev_write(struct file *file, const char *buffer size_t count, loff_t

*ppos)

{

/* The write function in pseudo code */

write(fd,“WRITE”+ process id + “I” + string of count + “I” + the data stored in

array buf);

}
ssize_t mydev_close(struct inode *inode, struct file *file)
{

/* The close function in pseudo code */

write(fd,“CLOSE”+ process id + “I”);

}

Note that the above program is only in pseudo code. The serialized formats for open, ioctl, write, and close system calls are the same as those presented in previous sections.

Audio-Sending and Audio-Receiving Daemons

There is always an audio-sending daemon associated with an audio data relay. The audio-sending daemon continuously reads serialized system calls stored in the audio data relay (a FIFO special file) and forwards them to an audio-receiving daemon in a remote computer via the network. A TCP connection is applied, but not necessarily limited to, in the invention to perform data transmission.

The audio-receiving daemon parses the received serialized system calls to identify open, write, ioctl, and close system calls. First, the open, ioctl, write, and close system calls from different processes are isolated according to the process IDs. Then, the audio-receiving daemon performs audio mixing of these isolated system calls from different processes. Finally, according to the mixed audio data, it invokes the appropriate open, ioctl, write, and close system calls to its audio file “/dev/dsp”.

Difficulties are experienced in meeting the real-time requirement if there is no synchronization mechanism between the audio-sending and audio-receiving daemons, due to too many of the serialized system calls being sent to the audio-receiving daemon staying at the network buffer in certain situations. In this case, after the audio application stops the sound from playing, the audio-receiving daemon can still obtain the buffered serialized system calls from the network. Thus, the playing of sound cannot stop immediately.

Please refer to FIG. 2. This problem is solved by having the system-call serializer 2c wait for an acknowledgement 4 after it sends serialized system calls to the audio data relay 2d. Whenever the audio-receiving daemon 2f receives a data packet, it first parses it, performs audio mixing, and invokes the appropriate system calls. It then informs the system-call serializer 2c whether it has finished the process of the received serialized system calls correctly or not by sending an acknowledgement. The acknowledgement includes the return value and parameters of the system call execution. The acknowledgement can either send to the system-call serializer directly or via the audio-sending daemon. The system-call serializer then passes the return value and parameters back to the caller of the system call. After that, the audio-sending daemon can then continue to read serialized system calls from the audio data relay, and continuously repeat the process.

Handling of Multiple Audio Devices

There are always several audio devices in an UNIX operating system. The MuNAS of the present invention can also handle multiple audio devices in a single computer.

This can be achieved in two ways. First, an audio data relay is arranged for each audio device for each user. For example, a user with ID 500 could have “/tmp/myAUDIO_{—}500”, “/tmp/myDSP_{—}500”, “/tmp/myMIXER_{—}500”, “/tmp/mySNDSTAT_{—}500”, “/tmp/mySEQUENCER_{—}500”, “/tmp/myMUSIC_{—}500”, “/tmp/myMIDI_{—}500”, “/tmp/myDMFM_{—}500”, and “/tmp/myDMMIDI_{—}500” as his or her audio data relays for “/dev/audio”, “/dev/dsp”, “/dev/mixer”, “/dev/sndstat”, “/dev/sequencer”, “/dev/music”, “/dev/midi”, “/dev/dmfm”, and “/dev/dmmidi”, respectively. It is obvious that each of his or her audio data relays should be associated with a pair of audio-sending and audio-receiving daemons to perform audio data transformation.

Another way is to have the serialized system calls contain information about the name of the audio device. For example, “OPEN1285|/dev/dsp|” and “OPEN1285|/dev/midi|” could represent requests of the process with ID 1285 to open “/dev/dsp” and “/dev/midi”, respectively. Examples of serialized system calls with device-name embedding of ioctl, write, read, and close system calls are “IOCTL1285|/dev/dsp|3221508099|1|”, “WRITE1285|/dev/dsp|1000|-------”, and “CLOSE1285|/dev/dsp|”, respectively.

According to the multi-user network audio system (MuNAS) in UNIX-based operating systems of the present invention, audio applications use traditional open, ioctl, write, read, and close system calls to audio devices, rather than having to invoke a special audio library. Thus, a user can use legacy audio applications in the innovative audio system without modification or recompilation. The audio system of the present invention extends the X window system by providing network audio functionality. The implementation of the present invention in Linux shows that it is practical and provides good performance in an ordinary LAN (100 Mbps) and IEEE 802.11 b wireless LAN (11 Mbps) environment.

An Audio Mixer in a Standalone Computer

In addition to being a multi-user network audio system, the MuNAS can also be an audio mixer in a standalone computer. Audio systems such as the open sound system (http://www.opensound.com) in Unix have a problem that an audio device can only be used by a single process simultaneously. For example, the three audio applications mplayer, realplayer, and alsaplayer in Linux can only work exclusively because they occupy the “/dev/dsp” and “/dev/mixer” device files during executing.

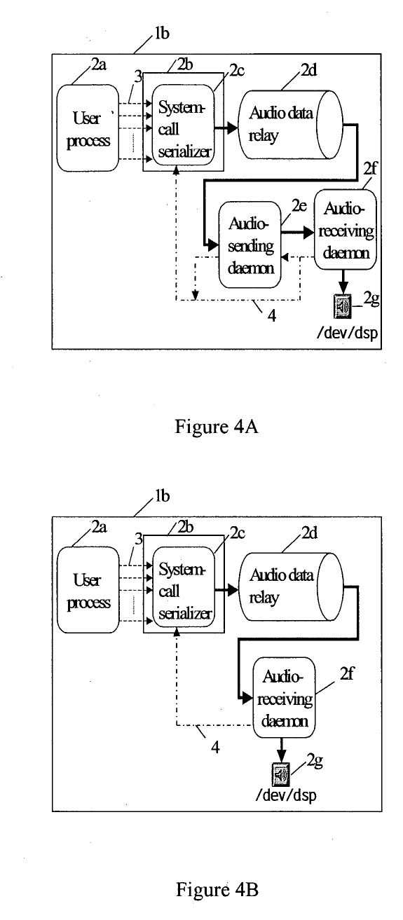

The present invention also provides a solution to this problem. In an embodiment, please refer to FIG. 4A, the system call serializer 2c, audio data relay 2d, audio-sending daemon 2e, and audio-receiving daemon 2f are combined in the same computer. It is obvious that there is no need to activate network communication between audio-sending daemon 2e and audio-receiving daemon 2f.

In another embodiment, please refer to FIG. 4B, it is similar to the previous one except that it removes the audio-sending daemon 2e and have the audio-receiving daemon 2f read the serialized system calls directly from the audio data relay 2d. The audio-receiving daemon 2f performs the audio mixing for the audio data from different processes and sends the mixed audio data to the device files.

The above detailed description of the preferred embodiments is to clearly describe features and spirit of the present invention and is not to limit the scope of the present invention. Various possible changes and equivalent modifications are intended to be covered by the present invention. Therefore, the scope of the present invention should be interpreted based on the following claims together with the above descriptions in the broadest way.

1. A multi-user network audio system on Unix-based operating systems, the system comprising:
a system-call serializer configured to serialize system calls issued by a user process;
an audio data relay configured to receive the serialized system calls from the system-call serializer; and
an audio-sending daemon configured to read the serialized system calls stored in the audio data relay and send the serialized system calls to an audio-receiving daemon in a remote computer, wherein the audio-receiving daemon deserializes the received serialized system calls and invoke system calls to an audio device file of the remote computer.

2. The multi-user network audio system of claim 1, wherein the system-call serializer encodes the name and all the arguments of the system calls into a stream of bytes.

3. The multi-user network audio system of claim 1, wherein the system-call serializer is configured to modify system calls in a kernel.

4. The multi-user network audio system of claim 1, wherein the system-call serializer is configured to write a new device driver for a sound device.

5. The multi-user network audio system of claim 1, wherein the system calls comprise open, write, ioctl, and close system calls.

6. The multi-user network audio system of claim 1, wherein the system calls further comprise read system calls.

7. The multi-user network audio system of claim 1, wherein the audio data relay is a FIFO file.

8. The multi-user network audio system of claim 1, wherein the audio data relay is a message queue of interprocess communication.

9. The multi-user network audio system of claim 1, wherein the audio data relay is user-specific.

10. The multi-user network audio system of claim 1, wherein the audio-sending daemon is user-specific.

11. The multi-user network audio system of claim 1, wherein the deserilaizing of the audio-receiving daemon comprises parsing the received serialized system calls to, identify system calls from different processes.

12. The multi-user network audio system of claim 1, wherein the audio-receiving daemon further performs audio mixing after parsing the received serialized system calls.

13. The multi-user network audio system of claim 1, wherein the system performs an acknowledgement process.

14. The multi-user network audio system of claim 13, wherein the acknowledgement process is accomplished by having the system-call serializer wait for an acknowledgement after sending serialized system calls to the audio data relay.

15. The multi-user network audio system of claim 14, wherein the acknowledgement comprises return value and parameters of system call execution.

16. The multi-user network audio system of claim 1, wherein the audio device file comprises any audio device files with the form of /dev/audio, /dev/dsp, /dev/mixer, /dev/sndstat, /dev/sequencer, /dev/music, ,dev/midi, /dev/dmfm, or /dev/dmmidi.

17. The multi-user network audio system of claim 1, wherein the system handles multiple audio devices in a single computer by arranging an audio data relay for each audio device for each user.

18. The multi-user network audio system of claim 1, wherein the system handles multiple audio devices in a single computer by having the serialized system calls contain information about the name of an audio device.

19. An audio mixer in a standalone computer, comprising:
a system-call serializer configured to serialize system calls issued by a user process;
an audio data relay configured to receive the serialized system calls from the system-call serializer; and
an audio-sending daemon configured to read the serialized system calls stored . in the audio data relay and send the serialized system calls to an audio-receiving daemon in the computer, wherein the audio-receiving daemon deserializes the received serialized system calls and invoke system calls to an audio device file of the computer.

20. An audio mixer in a standalone computer, comprising:
a system-call serializer configured to serialize system calls issued by a user process;
an audio data relay configured to receive the serialized system calls from the system-call serializer; and
an audio-receiving daemon, configured to read the serialized system calls stored in the audio data relay and deserialize the received serialized system calls and invoke system calls to an audio device file of the computer.

21. A multi-user network audio method on Unix-based operating systems, comprising:
serializing system calls issued by a user process;
sending the serialized system calls to an audio data relay;
sending the serialized system calls in the audio data relay to an audio-receiving daemon in a remote computer;
deserializing the serialized system calls; and
invoking system calls to an audio device file of the remoter computer.

22. A multi-user network audio system on Unix-based operating systems, comprising:
means for serializing system calls issued by a user process;
means for ending the serialized system calls to an audio data relay;
means for sending the serialized system calls in the audio data relay to an audio-receiving daemon in a remote computer;
means for deserializing the serialized system calls; and
means for invoking system calls to an audio device file of the remoter computer.
